(19) United States
(12) Patent Application Publication
(10) Pub. No.: US 2007/0175084 A1
(43) Pub. Date: Aug. 2, 2007

(54) Manufactured Fly Form for Use with A Hook-less Fly

(76) Inventor: Patrick E. Moffitt, Califon, NJ (US)

Correspondence Address: DIEHL SERVILLA LLC, Suite 110, 77 Brant Avenue, Clark, NJ, 07066, US

(21) Appl. No.: 11/469,067

(22) Filed: Aug. 31, 2006

Related U.S. Application Data
(60) Provisional application No. 60/713,988, filed on Sep. 2, 2005.

(51) Int. Cl. A01K 85/08

(52) U.S. Cl. 43/42.25; 43/42.24

(57) ABSTRACT

A fly core and a method of making a fly are disclosed. The fly core includes a core, a line attachment structure and a line orientation structure. The line attachment structure and the line orientation structure are preferably located at opposite ends of the core. The core is preferably a single material with a Shore A Hardness less than 55 and is coated with a coating. The core can have ridges and can have an indent capable of holding a bead in place. The fly core does not include a hook.

### STATEMENT OF RELATED CASES

This patent application claims the benefit of and priority to U.S. Provisional Patent Application No. 60/713,988, filed Sep. 2, 2005, which is hereby incorporated by reference.

### BACKGROUND OF THE INVENTION

The invention relates to an improved method of crafting a hook-less artificial fly capable of being attached to a line at a distance from a hook as well as to an improved hook-less artificial fly.

The separation of fly and hook at a material distance on the angler's line results in only the hook-less fly being taken into the fish's mouth. This orientation is not meant to restrict or prevent an angler from positioning the fly in close proximity to the hook.

Separating hook and fly at a material distance along the line allows an angler when reacting to a fish's take to draw the line through the fish's mouth and engage the hook in the fish's outer jaw. The hook, not initially entering the fish's mouth, simultaneously with the hook-less artificial fly, cannot pierce sensitive anatomical structures such as the tongue and gill arch. The hook's location in an exposed jaw position allows for quick removal. The reduction of handling stress and the prevention of hook related injuries increases a fish's chance for post-release survival.

Hook-less artificial flies are crafted on a fly form or core containing two structural components: a line attachment structure and the fly body upon which the fly is crafted. The line attachment structure allows the fly to be affixed to any point on the angler's line such that the fly remains yieldingly in place, above the hook, while casting. The fly body forms the base upon which the fly pattern is crafted.

Some fly types also benefit from incorporation of a third component called a line orientation structure. This structure is generally a loop of material located on the distal end of the fly opposite the line attachment device. The line orientation structure allows the angler to thread a length of line and attached hook through the orientation device keeping line, hook, and fly parallel. The structure can be open or closed.

### SUMMARY OF THE INVENTION

In accordance with one aspect of the present invention, the fly tying process is aided by using a pre-manufactured fly form/core. The fly form/core can be manufactured as an integral unit incorporating fly body, line attachment device and with or without a line orientation structure. Additionally, the fly form/core can be manufactured as discrete components capable of being assembled prior to or during the fly tying process.

In accordance with one aspect of the present invention, a fly core is provided. The fly core includes a core, a line attachment structure and a line orientation structure. The line attachment structure and the line orientation structure are preferably located at opposite ends of the core.

In accordance with another aspect of the present invention, the core is a single material with a Shore A Hardness less than 55. In accordance with a further aspect of the present invention, the core can also be a single material with a Shore A Hardness in the range of 30 to 55.

The core can be coated with a coating. The core can also be enmeshed with a coating. The core can also have one or more ridges. The core can also have an indent capable of holding a bead in place.

In accordance with a further aspect of the present invention, there is no hook in the fly core.

In accordance with yet another aspect of the present invention, a fly is provided. The fly includes a core, a line orientation structure integral to the core and a line attachment structure attached to the core. Once again, in accordance with a preferred embodiment, there is no hook in the fly core.

The core and the line attachment structure can be made from equivalent materials or can be made from different materials.

The line attachment structure can have an attachment post and the core can be adapted to receive the attachment post. The line attachment structure can have an attachment post that has ridges or barbs.

In accordance with a further aspect of the present invention, a core for an artificial fly for receiving tying materials is provided. The core has a distal end of the core and has a bulge that inhibits the tying materials from unraveling from the distal end of the core.

The bulge can have slits adapted to receive a tail in a preferred orientation.

In accordance with another aspect of the present invention, a fly core is provided. The fly core includes a fly body and a line attachment structure, wherein the fly body is made of a braided material. The fly body and the line attachment structure can be made from the same material. The braided material can be Dacron or nylon. The braided material can be hollow. The braided material can envelop or cover an elastic core material. The braided material can be coated with an anti-skid material.

### BRIEF DESCRIPTION OF THE DRAWINGS

FIG. 1 shows a plan view of a pre-manufactured fly form/core with an integral fly body, upon which the fly is crafted and an integral line attachment device in accordance with one aspect of the present invention.

FIG. 2 shows in plan view another embodiment of the fly form/core demonstrating the fly body is not constrained by a given shape, in accordance with another aspect of the present invention.

FIG. 3 shows a fly form/core incorporating a distal structure aiding in the positioning of fly tying materials.

FIG. 4 shows a fly form/core with a fly body optionally incorporating ridges, notches or associated appendages that can aid a finished fly's structural stability.

FIG. 5 demonstrates the fly body in accordance with the present invention is not constrained by length or geometric shape and may take any desired shape.

FIG. 6 shows a fly body in profile, seated on a mandrel, and made of a material incapable of being compressed by the tying threads normally used in the fly tying industry wherein the fly form's shape not only aids in the reduction of the fly body twisting during the tying process, but improves a finished fly's structural stability when constructed of non-elastic or compressible material.

FIG. 7 shows a line attachment structure manufactured as a separate component and capable of attachment to the fly body during fly tying which may incorporate appendages aiding in the ultimate connection to the fly body and which has the ability to also serve as a line orientation device.

FIG. 8 shows a line attachment device formed by joining two separately manufactured components, in accordance with one aspect of the present invention.

FIG. 9 shows a line attachment device, that by means of an attached post, can be inserted directly into a fly body prior to, during or following completion of crafting a hook-less artificial fly.

FIG. 10 shows a fly form manufactured as a single and integral unit incorporating the components of a line attachment structure, fly body and optional line orientation structure.

FIG. 11 shows a fly form/core rigged using the line orientation structure whereby the line attachment structure's primary requirement is to attach the fly to the fishing line while the distal line orientation device orients the fishing line along a desired axis of the fly body.

FIG. 12 shows a fly core adapted to seating a bead and preventing said bead from slipping free of the fly core wherein the fly form/core's shape as such eliminates the requirement to either glue the bead in place or by the use of thread or other such means wrap sufficient material around the fly body at a site between the bead and the line attachment structure to prevent the beads movement.

FIG. 13 shows an alternate fly core adapted for seating a bead whereby an elastic fly form/core is pulled through a hollow bead and is allowed to seat on or between one or more structural elements.

### DESCRIPTION OF PREFERRED EMBODIMENTS

A hook-less fly is created by inserting a mandrel into a fly tying vice. The mandrel's cross section is preferably smaller than the cross section of the fly body onto which the fly is tied. The fly form/core is first attached to the mandrel by means of tying thread or the mandrel is inserted into the fly form/core. The fly can then be crafted using well known tying techniques. The fly, when completed, is pulled free from the mandrel.

The mandrel can be composed of any material showing sufficient strength not to bend or break under the pressures normally imposed by the fly tying process. The mandrel is most often a metal such as steel or graphite in composition. The mandrel may be further coated with a low friction material such as Teflon to ease the removal of a fly when finished tying from the mandrel. Additionally, the mandrel may be coated with materials to prevent the various glues that may be used in the fly tying process from adhering to the mandrel.

A fly form/core can also be created by folding a length of rubber string and fixing it to the mandrel by means of tying thread. The loop created by the rubber string is left exposed to form the line attachment structure used to yieldingly attach fly to the line. In a preferred embodiment, the connection of hook-less fly to line is accomplished by passing a loop of line through the line attachment device, passing the loop over the fly body and then securing the loop to the attachment device.

The fly form/core and/or associated components when manufactured separately can be created by a variety of methods, including but not limited to, injection, press molding, extrusion and stamping. The fly core, or any one of its components once formed, may be subject to further manufacturing operations such as spray coating, dipping or similar processes. Secondary manufacturing processes may apply additional materials to create a desired characteristic such as tear resistance, stiffness, weathering or increase the coefficient of friction. The various components comprising the fly form/core are not required to be equivalent in composition or manufacturing process.

Certain fly patterns benefit from a fly body having a Shore Hardness less than 55 A. A fly body made of a relatively soft and resilient or elastic material allows the pressure exerted by the fly tying thread, during tying, to compress the body material. The fly's structural integrity is maintained when removed from the mandrel by the resilient fly body rebounding and filling the void left by the mandrel. This allows tension on the thread wraps to be maintained and the attached material affixed to the fly. Larger flies may be effectively tied with a harder fly body material, greater than a Shore A Hardness of 55 however the fly body must be sufficiently large in relation to the mandrel's cross section and appropriately shaped such that the void produced when the fly is removed from the mandrel does not undermine the fly's structural integrity. A significant void left within the fly body will release tension from the wrappings that hold the various materials in place and allow the hook-less fly to unravel.

A ventral notch or other such shape in the fly body capable of seating on the mandrel during the fly tying process can reduce the impact of any residual void left by the mandrel on a finished fly's structural integrity.

A mandrel of the proper shape when fitted to a mirrored or reversed shape on the fly body can reduce the incidence of the fly body twisting or rotating on the mandrel during the fly tying process.

Less resilient materials may also be used in the construction of a fly body when adhesives are used to insure structural stability. A desired stiffness of the fly body can also be achieved by adding a stiffener such as a length of wire or nylon monofilament during the fly tying process. A stiffener can be used in conjunction with a highly resilient/elastic fly body and simultaneously achieve a stiffened fly body that is at the same time sufficiently elastic to prevent an unwanted void in a finished fly. Such a combination will overcome the void problem and insure structural ability while allowing desired body stiffness in the finished fly.

A line attachment structure may be manufactured simultaneously with the fly form/core or as a separate component attached during the fly tying process. The device may take alternate shapes and incorporate various materials of construction. In one variation, a line attachment structure takes the form of a small eye structure (the size of the opening in the line attachment structure is a function of a number of variables including coefficient of friction, hardness, elasticity and the size of the hook-less fly) manufactured with a resilient material having a Shore Hardness A of less than 80, good tear strength and appropriate environmental resistance to decomposition. A coefficient of friction is desired such that the line attachment device when affixed to the line by means of a loop, allows the fly to remain in place on the line while casting. The resilient material, in accordance with another aspect of the present invention, has a Shore Hardness A in the range of 30 to 55.

A material that may have acceptable design characteristics other than the coefficient of friction may also be used as the line attachment structure by applying a secondary material to the line or line attachment structure to achieve the required friction between fly and line to keep the fly yieldingly in place. A material with tacky, adhesive or high friction qualities may be added to the line attachment device during manufacturing by spray coating or similar manufacturing process, added while tying the fly or by the angler prior to using the fly.

The line attachment structure may also be crafted from a braided or hollow braided material such as nylon, Dacron, spectra or other such material used to make a braided line. The braided line my also be coated with a high friction or anti-slip compound to help keep the fly in place while casting. The braided line used to make the line attachment structure may or may not have an internal elastic core of similar or dissimilar material.

A line attachment structure can be created capable of being attached to a more rigid pin-like structure. The line attachment structure once affixed to the pin can be inserted into a fly body. The method is especially applicable when tying flies with open or closed cell foam bodies. The device once inserted into the fly body is held in place by means of barbs, friction thread wraps and/or adhesive.

A line attachment device may also be constructed with materials harder than 55 Shore A or a material with a coefficient of friction that easily allows the fly to slip while casting. The maximum hook-ward slip of the fly on the fishing line can be limited in such a case by adding a structure, called a stop, to the fishing line that prevents the passage of the hook-less fly's line attachment device beyond said device. This is most easily accomplished by having the stop attached to the fishing line be of a diameter greater than the opening of the hook-less fly's line attachment device. The stop can be crimped, knotted, glued or threaded onto the fishing line which, in effect, limits the maximum fly movement in the direction of the hook. This may also be an aid when heavily weighted flies are used. Alternately, the line may have a high friction coating added to the line to prevent fly slippage of the hook-less fly while casting.

The orientation of the line attachment structure's opening can be a critical factor to the proper presentation of hook-less flies. The structure's opening can therefore be designed parallel to the fly's dorsal and ventral surface or rotated up to 90 degrees. The line attachment structure may also be formed at any angle relative to the long axis of the fly body.

Large and/or wind resistant flies can benefit from the incorporation of a distal line orientation structure. The structure is not necessarily used as a line attachment point but serves to orient the line along a preferred axis of the fly. This has the benefit of reducing line twist when using wind resistant dry flies, orienting hook and line to the long axis of streamer patterns and allowing nymph patterns to properly orient with respect to the water's current. The line orientation device can be made of any material and its shape constrained only by its purpose of keeping the fly and line oriented to a desired plane. It is not constrained by the engineering or material constraints of the line attachment structure.

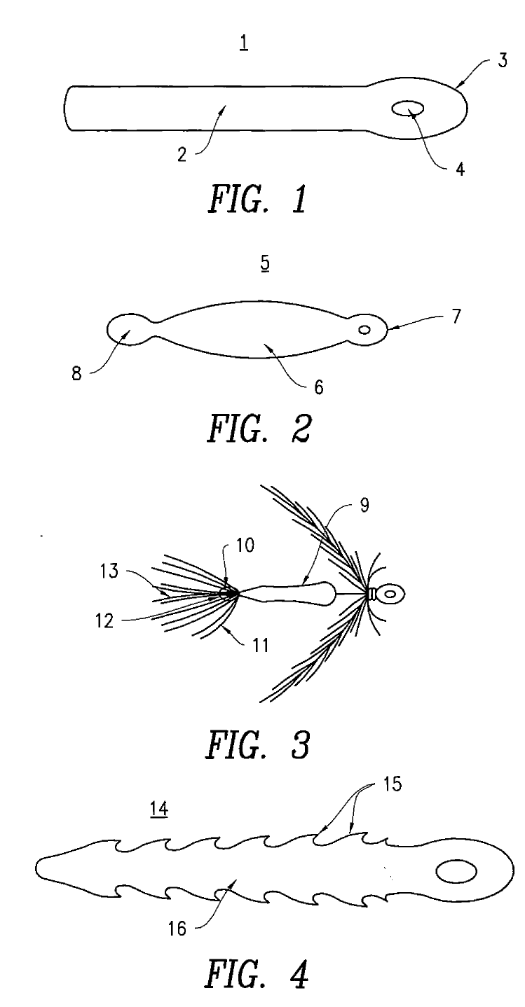

In a preferred embodiment a pre-manufactured fly form/core incorporating a fly body (upon which the fly is crafted) and line attachment structure is shown in FIG. 1. The fly core can be manufactured by a variety of processes including injection and compression molding, extrusion, or other manufacturing processes known to the art of plastic manufacturing. The materials of construction can include elastomers, thermoplastics or other suitable materials.

Many nymph and dry fly patterns benefit from a fly core/form constructed of a material with a Shore A Hardness less than 55 and exhibiting characteristics of high tear strength, elasticity and resistance to weathering from ozone and other conditions experienced when fishing or in storage.

Artificial flies are required to fish various depths along the water column. Dry flies are designed to maximize flotation while many nymph patterns require a fast sink rate. A fly core can use various materials formulated to achieve a desired specific gravity either to enhance flotation or sink rate. A plastic formulation, as an example, used in a particular fly form/core may incorporate additives to achieve a higher specific gravity or increased sink rate. The addition of tungsten to a synthetic rubber or other plastic formulation to achieve a fast sinking fly core is but one example.

Two or more separate and distinct materials may comprise the fly core/form. The use of coatings may provide a desired stiffness, tear resistance, friction or environmental resistance.

Artificial flies are required in various lengths. A fly core can be produced with a body length that is sufficiently long to cover broad classes of flies allowing a fly tyer to cut a fly body to the desired length prior to tying the fly. The fly body may contain markings along its length to aid the fly tyer in creating a properly sized fly. The form can additionally be manufactured in discrete sizes. Additionally the materials of construction can be formulated to mimic a desired color especially useful for the exposed line attachment device. The fly core can also be manufactured in a neutral color allowing the fly tyer to color the exposed fly core sections with indelible markers.

The fly body as shown in FIG. 2 can take any appropriate shape needed to achieve a desired fly design. Certain aquatic insects, as an example, are defined by an extremely flattened and tapered body. A conventional fly built on a hook requires the tyer to build this shape by means of thread and/or inserts. The fly body section of a hook-less fly core can be molded to assume shapes not possible for hooks.

The distal end of the fly body shown in FIG. 2 may terminate in a variety of shapes that help prevent the fly thread and/or material from unraveling. The distal bulge or swelling can also assist the fly tyer properly attaching tailing materials required of certain dry fly patterns as shown in FIG. 3. The distal bulge can assist in splaying the tailing material or contain slits to affect a similar result.

The fly body may also be manufactured with indents, notches or ridges as shown in FIG. 4 that help keep the fly tying materials in place and adds to the fly's structural integrity especially when the fly body is made of a highly elastic material.

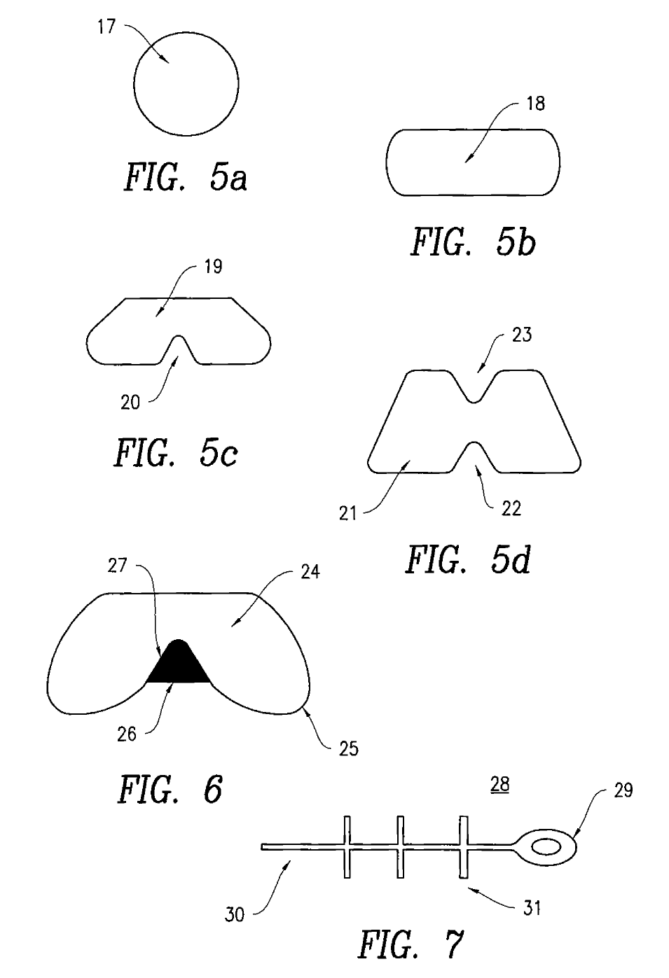

In one aspect of the invention, the cross-section of a fly body, as shown in FIG. 5 a-d, may vary as a function of the fly pattern desired and be of any required geometry. The shape of the fly body is restricted only by the necessity to tie a fly that is structurally sound and mimics a desired food item. Structural integrity is achieved when the void in the hook-less fly, created when pulling the fly free of the mandrel, is eliminated by the fly body's resilient material rebounding to close the void. This suggests the fly body must initially be larger in cross-section than the mandrel upon which it is tied. Further the fly body must be capable of being compressed during tying, at a minimum, equal to the cross-sectional area of the mandrel. The fly body may also benefit from a ventral notch as shown when a less resilient material is used. The notch when fitted over the mandrel prevents the fly body from spinning on the mandrel and also diminishes the contact between the tying thread and the mandrel.

Some fly patterns, such as streamers, may benefit from a fly body composed of a stiffer and/or harder fly body. The width and shape of the fly body, as shown in FIG. 6, can be manufactured in such a way that the mandrel void does not ultimately present a structural problem when the fly is removed. A properly designed fly body allows the fly body to be seated on the mandrel and inhibits a tendency of the fly body to twist on the mandrel while tying. Additionally, a fly body as configured in FIG. 6 allows the use of a non-resilient fly body of a material with a Shore A Hardness greater than 55. The mandrel recessed within the fly body minimizes the tying threads from coming into material contact with the mandrel. A void, therefore, and resulting structural instability is not created in a finished hook-less fly when removed from the mandrel.

The line attachment structure, as shown in FIG. 7, may be formed with a post structure capable of being affixed to the fly body during the tying process. The post structure may have associated barbs or appendages aiding in binding or gluing the device to the fly body.

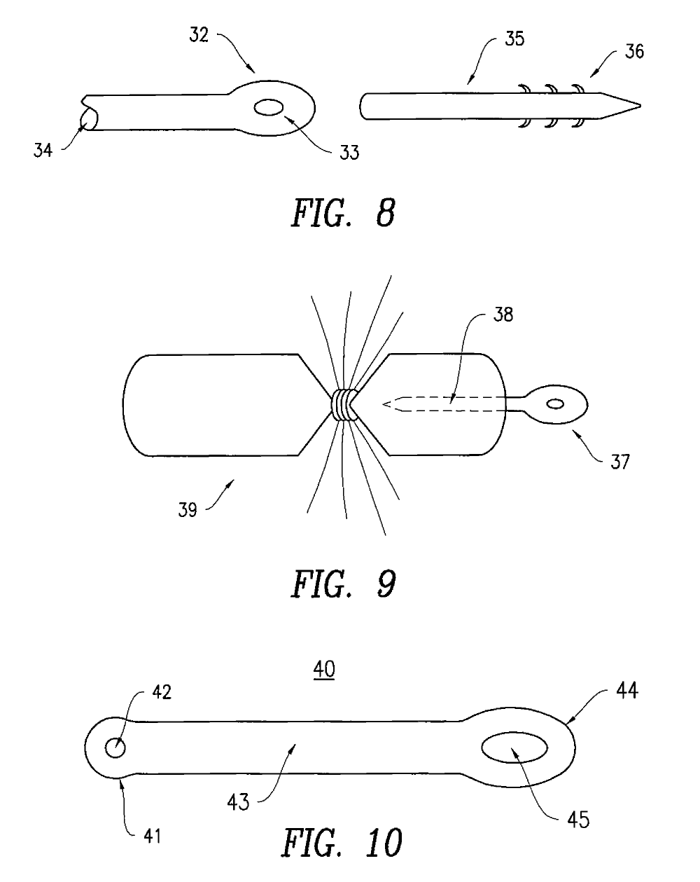

Certain dry flies use foam cylinders to mimic the bodies of various terrestrial insects such as ants and bees. Tying speed and structural integrity is enhanced by manufacturing a line attachment device, shown in FIG. 8 that can be slip fitted and/or glued to a hard plastic or metal post. Barbs along the post structure may enhance the connection of fly body and line attachment device. The line connection's post is ultimately inserted into the fly body core during the pre or post fly tying process.

FIG. 9 shows a hook-less foam dry fly in profile and the inserted line attachment structure described for FIG. 8.

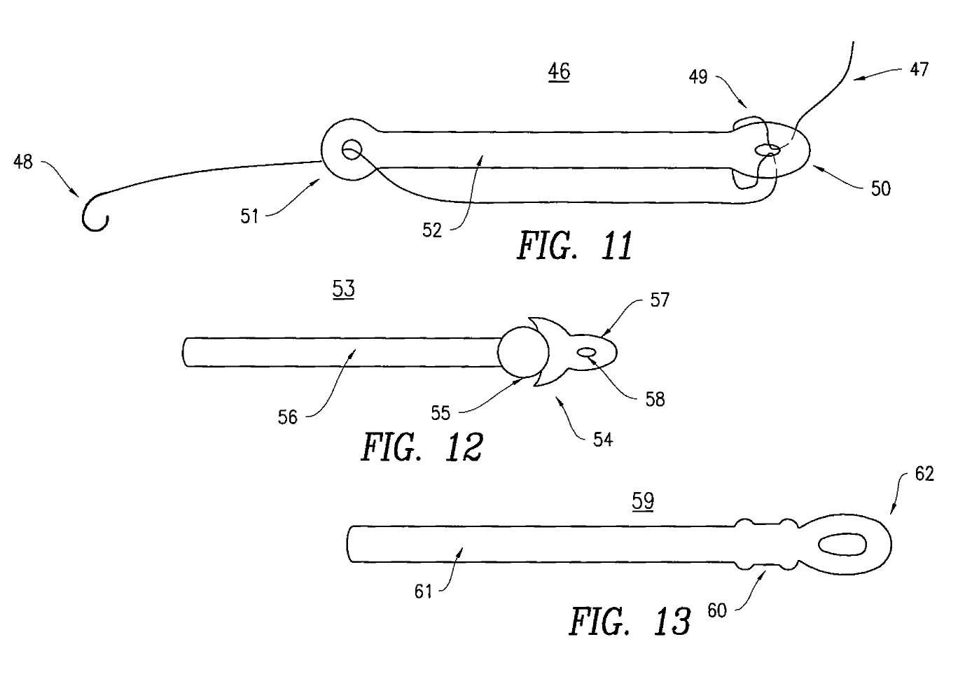

FIG. 10 shows a pre-manufactured fly form/core that includes an optional line orientation structure. Some flies, including streamers and large dry flies, benefit from the addition of a line orientation structure. The line orientation structure has only one function and that is to keep the line and fly parallel to a desired fly body axis as shown in FIG. 11. The line orientation structure may also be attached during the fly tying process and is generally not limited by materials of construction or design as long as the intended function is met.

Many flies incorporate beads into the pattern. The bead is attached to a conventional fly by threading the bead over the point of the hook, threading it around the hook's bend and along the hook shank until it abuts the hook eye. The diameter of the hook eye prevents the bead from further forward movement. The fly pattern is constructed immediately behind the bead essentially locking it in place. The hook-less fly form can be manufactured with various designs to more efficiently hold a bead in place. Given that many hook-less flies incorporate a resilient line attachment structure, a means is necessary to secure the bead in place.

FIG. 12 shows a hook-less fly core with sufficient forward mass on the fly body to prevent a threaded bead from slipping over the line attachment structure. The bead may also be threaded on the distal end of the fly body until it abuts this bead stop device or the line attachment structure pulled through the hollow bead and over the stop device when using an elastic core material. FIG. 13 shows a further embodiment for bead attachment using a mounting structure. A small crochet hook or loop of line can be inserted into a hollow bead and hooking the line attachment device. The resilient material forming the line attachment device is then pulled and stretched through the bead such that when relaxed the bead fits tightly to the fly body's bead mounting structure. A bead mounting structure can also be used when crimping beads to the fly body.

Various aspects of the present invention will now be discussed with respect to the drawings.

FIG. 1 shows a manufactured hook-less fly form/core 1 that includes a fly body section 2 upon which the fly pattern is ultimately crafted, a line attachment structure 3 containing incorporating an opening 4 through which a loop of line can be threaded to affix the finished fly to an angler's line.

FIG. 2 shows a manufactured fly form/core 5 demonstrating the fly body 6 can be made to achieve any desired and useful shape or length. The fly body 6 in this case is manufactured as a single unit with the line attachment structure 7. The fly body 6 can terminate in a structure 8 that aids in preventing the fly thread and/or material from unraveling off the distal end of the fly.

FIG. 3 shows a plan view of a hook-less fly 9 where the terminal structure 10, described in FIG. 2, can prove useful in the proper orientation of tailing material 11 achieved by separating the tailing fibers to form a v-shape required of some fly patterns. Various slits or indents 12 may be formed in the distal bulge 10 to allow a section of the tailing material 13 to orient with the long axis of the fly 9.

FIG. 4 shows a fly form 14 with ridges, indents, or related appendages 15 along the entire length or section of the fly body 16 as well as along any plane or surface. The ridges can aid the structural integrity of a completed hook-less fly.

FIG. 5 a, b, c, and d show various fly form cross-sections demonstrating the fly body is not constrained by geometric shape. FIG. 5a shows a fly body oval 17 in profile and 5b shows a fly body 18 rectangular in profile. FIG. 5c shows a fly body profile 19 with a ventral notch 20 capable of being seated atop a mandrel. FIG. 5d shows a fly body 21 in profile containing a ventral notch 22 for the mandrel and a dorsal notch 23 for the insertion of a stiffener or weight.

FIG. 6 shows a non-resilient fly body 24 in cross section having lateral sides 25 that extend beyond the depth of the mandrel 26 upon which the fly body 24 is seated during fly tying. The fly body's incorporated notch 27, when fitted to the mandrel 26, prevents the fly body 24 from spinning during tying. By minimizing contact of the tying thread with the mandrel allows the manufacture of a fly body with a Shore Hardness greater than 55 A.

FIG. 7 shows a manufactured line attachment structure 28 with line opening 29 attached to a post structure 30 that may or may not contain barbs 31 or similar appendages that aid in securing the line attachment device to a fly body.

FIG. 8 shows a line attachment structure 32 with line opening 33 terminating in a tube 34 capable of accepting a post 35 that may or may not have barb attachments 36. The post 35 is inserted in the tube end 34 of the line attachment device 32 and held together by adhesives or friction. The components 32 and 33 do not need to be made of similar material.

FIG. 9 exhibits a completed line attachment device 37, as described in FIG. 8, whereby the post structure 38 is sufficiently rigid and extends a sufficient distance beyond the distal end 32 that it can be inserted into a foam bodied hook-less fly 39. The connection of fly body 39 and post structure 38 may be aided by the addition of barbs to the post structure 38 and/or the addition of an appropriate adhesive.

FIG. 10 shows a manufactured fly form/core 40 incorporating an integral line attachment structure 41 with line opening 42, fly body 43 with a generic shape and distal line orientation structure 44 with line opening 45 manufactured as a single integral unit.

FIG. 11 shows a typical rigging for a hook-less fly core (pattern omitted) 46 as described in FIG. 10. A line 47, terminating in a hook 48, has been loop connected 49 to the fly's line attachment device 50. The hook 48 is passed through the line orientation structure 51 such that the line 47 and the long axis of the fly body 52 are parallel.

FIG. 12 shows one variation of an elastic/resilient manufactured fly form/core 53. The fly core 53 incorporates a structure 54 sufficiently large to prevent a hollow bead 55 when passed over the fly body 56 from sliding over the line attachment structure 57 and associated line opening 58 when tension is released.

FIG. 13 shows an elastic/resilient fly form/core 59 with a bead mounting structure 60 located between the fly body 61 and the line attachment structure 62. A hollow bead threaded and stretched over the line attachment structure 61 and over the terminal end of the bead structure 60 is held in place on the fly form/core when tension is released.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

1. A fly core, comprising:
a core;
a line attachment structure; and
a line orientation structure.

2. The fly core of claim 1, wherein the line attachment structure and the line orientation structure are located at opposite ends of the core.

3. The fly core of claim 1, wherein the core is a single material with a Shore A Hardness less than 55.

4. The fly core of claim 1, wherein the core is a single material with a Shore A Hardness in the range of 30 to 55.

5. The fly core of claim 1, wherein the core is coated with a coating.

6. The fly core of claim 1, wherein the core is enmeshed with a coating.

7. The fly core of claim 1, wherein the core has one or more ridges.

8. The fly core of claim 1, wherein the core has an indent capable of holding a bead in place.

9. The fly core of claim 1, wherein there is no hook in the fly core.

10. A fly, comprising:
a core;
a line orientation structure integral to the core; and
a line attachment structure attached to the core.

11. The fly of claim 10, wherein there is no hook in the fly core.

12. The fly of claim 10, wherein the core and the line attachment structure are made from equivalent materials.

13. The fly of claim 10, wherein the core and the line attachment structure are made from different materials.

14. The fly of claim 10, wherein the line attachment structure has an attachment post and the core is adapted to receive the attachment post.

15. The fly of claim 10, wherein the line attachment structure has an attachment post that has ridges.

16. The fly of claim 10, wherein the line attachment structure has an attachment post that has barbs.

17. A core for an artificial fly for receiving tying materials, comprising:
a core;
wherein a distal end of the core has a bulge that inhibits the tying materials from unraveling from the distal end of the core.

18. The core of claim 17, wherein the bulge has slits adapted to receive a tail in a preferred orientation.

19. A fly core, comprising:
a fly body; and
a line attachment structure;
wherein the fly body is made of a braided material.

20. The fly core of claim 19, wherein the fly body and the line attachment structure are made from the same material.

21. The fly core of claim 19, wherein the braided material is Dacron.

22. The fly core of claim 19, wherein the braided material is nylon.

23. The fly core of claim 19, wherein the braided material is hollow.

24. The fly core of claim 19, wherein the braided material envelops an elastic core material.

25. The fly core of claim 19, wherein the braided material is coated with an anti-skid material.

26. The fly core of claim 24, wherein the braided material is coated with an anti-skid material.
